(19) United States
(12) Patent Application Publication
(10) Pub. No.: US 2018/0208025 A1
(43) Pub. Date: Jul. 26, 2018

(54) SHADING DEVICE FOR A WINDOW OF A MOTOR VEHICLE

(71) Applicant: BOS GMBH & CO. KG, Ostfildern (DE)

(72) Inventors: Matthias MAIER, Esslingen (DE); Volker KLETT, Stuttgart (DE)

(21) Appl. No.: 15/736,478

(22) PCT Filed: Apr. 18, 2016
(86) PCT No.: PCT/EP2016/058515

§ 371 Date: Dec. 14, 2017

(30) Foreign Application Priority Data
Jun. 18, 2015 (DE) 10 2015 211 293.4

(51) Int. Cl. B60J 1/20

(52) U.S. Cl. CPC B60J 1/2027; B60J 1/2038; B60J 1/2052; B60J 1/2063; B60J 1/208

(57) ABSTRACT

A shading device for a window of a motor vehicle with a sheet-like structure which is held on a winding shaft so as to be able to be wound up and unwound between a wound-up inoperative position and a stretched protective position. The winding shaft is mounted rotatably in a vehicle-mounted receiving space closable by a closing part mounted pivotably between a closed position and an opening position. The sheet-like structure is provided with a pull-out profile shiftable parallel along the window by a drive system. The closing part is controlled by a control mechanism between two different opening positions, of which a first opening position opens up an opening permitting passage of the pull-out profile, and a second opening position opens up a reduced opening selected to be of a size sufficient in order to permit the sheet-like structure to pass through without contact.

The invention relates to a shading device for a window of a motor vehicle, with a flexible sheet-like structure which is held on a winding shaft so as to be able to be wound up and unwound between a wound-up inoperative position and a stretched protective position, which winding shaft is mounted rotatably in a vehicle-mounted receiving space which is closable by a closing part which is mounted pivotably between a closed position and at least one opening position, wherein the sheet-like structure is provided at its front end region in the unwinding direction with a dimensionally stable pull-out profile which is shiftable parallel along the window by means of a drive system.

A shading device of this type is known in general for a side window or a rear window of a passenger vehicle. The shading device has a flexible sheet-like structure which is held on a winding shaft so as to be able to be wound up and unwound. The winding shaft is mounted rotatably in a cassette housing. In order to shade the window, the flexible sheet-like structure is pulled out of the cassette housing and stretched along the window. The cassette housing is held fixed to the vehicle below the window. The cassette housing has a passage slot which defines an opening of the cassette housing upward. In an inoperative position, the sheet-like structure is completely wound up onto the winding shaft and the pull-out profile is deposited in the region of the passage slot in the cassette housing. The opening of the cassette housing is closable by a closing part which is configured as a flap and is mounted pivotably on a corresponding functional part of the vehicle interior. In the inoperative position of the sheet-like structure, the closing part closes the opening of the cassette housing and is transferred into its opening position when the pull-out profile and the sheet-like structure are extended upward out of the passage slot toward the window. In the stretched protective position of the sheet-like structure, the closing part remains in its opening position.

It is the object of the invention to provide a shading device of the type mentioned at the beginning which, with simple means, permits low-wear retraction and extension of the sheet-like structure relative to the receiving space and relative to the closing part.

This object is achieved in that the closing part is forcibly controlled by means of a control mechanism between at least two different opening positions, of which a first opening position opens up an opening permitting passage of the pull-out profile, and a second opening position opens up a reduced opening which is selected to be of a size sufficient in order to permit the flexible sheet-like structure to pass through without contact. The solution according to the invention is suitable in a particularly advantageous manner for shading a rear window of a passenger vehicle, in which a vehicle-fixed receiving space in the form of a cassette housing is positioned below a rear parcel shelf and an opening of the receiving space toward the vehicle interior is closed by a closing part in the form of a closing flap. In accordance with the inclination of the rear window, the flexible sheet-like structure is pulled out obliquely upward into its protective position and returned again obliquely downward. The drive system preferably has an electric motor which, by means of a suitable transmission, synchronously drives two pull-push strands which act with an end region on opposite end sides of the pull-out profile and thus permit longitudinal shifting of the pull-out profile between the inoperative position of the sheet-like structure and the protective position of the sheet-like structure.

The two opening positions which, according to the invention, are defined by the control mechanism serve firstly to be able to guide the pull-out profile, which is substantially thicker than the thin sheet-like structure, past the closing part without the pull-out profile touching the closing part. Secondly, even after the pull-out profile has been guided past in the pull-out direction, the closing part is intended to remain in an opening position which is reduced in comparison to the first opening position, in order to ensure that the closing part remains with a corresponding border edge at a distance from the sheet-like structure during a further pull-out movement of the sheet-like structure. Owing to the fact that the closing part remains held at a contactless distance from the sheet-like structure, the sheet-like structure cannot be damaged and also, by sliding past the closing part, cannot be exposed to increased wear.

In a refinement of the invention, the control mechanism is assigned to a lever arm of the closing part. The lever arm preferably extends in the region of a hinge arrangement of the closing part and is provided for exerting a lever action and accordingly a torque on the closing part. The closing part is preferably held in its closed position by means of a spring device. The lever mechanism acting on the lever arm exerts a torque on the closed part counter to the torque of the spring device.

In a further refinement of the invention, the control mechanism has a control link arranged in the region of the lever arm and a control cam which is movable along the control link, wherein the control link has various link track portions which define the two opening positions of the closing part. The link track portions preferably merge in a flowing manner into each other, and therefore no stepped shoulders arise between the various link track portions.

In a further refinement of the invention, the control link is arranged on the lever arm. The control link preferably extends at least substantially parallel to a pivot axis of the closing part.

In a further refinement of the invention, the control link is arranged on a guide track for the control cam. This corresponds to a kinematic reversal with respect to the arrangement of the control link on the lever arm.

In a further refinement of the invention, the drive system has two bendable, longitudinally extending pull-push strands which are operatively connected at an end region to the pull-out profile for parallel shifting, wherein at least one pull-push strand is guided by its opposite end region in a control guide in the region of the lever arm. The opposite end region of the pull-push strand is accordingly used as part of the control mechanism.

The pull-push strand should be understood as meaning a flexible means which is extended longitudinally and can transmit pull and push forces, such as a rack, a Bowden cable or a threaded shaft.

In a further refinement of the invention, the end region of the pull-push strand is provided with the control cam. The use of the pull-push strand of the drive system for the control mechanism obviates the need for any additional drive means. This refinement is advantageous if the control mechanism is only effective in the retraction and extension region of the pull-out profile. The supporting stop ensures that the closing part is also held in one of the two opening positions without the control mechanism being effective.

Further advantages and features of the invention emerge from the claims and from the description below of a preferred exemplary embodiment of the invention, which is illustrated with reference to the drawings.

FIG. 1 shows an embodiment of a shading device according to the invention schematically in a side view,

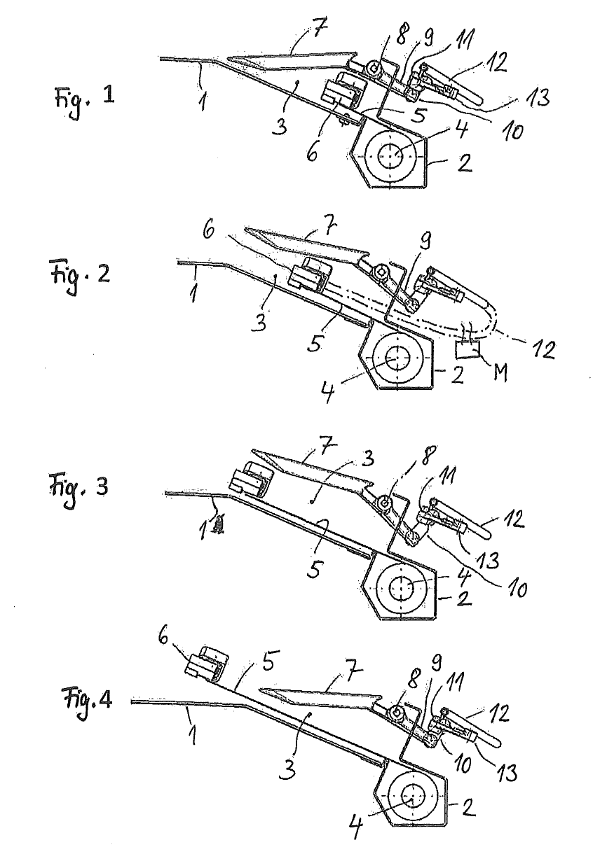

FIGS. 2 to 4 show the shading device according to FIG. 1 in different functional positions,

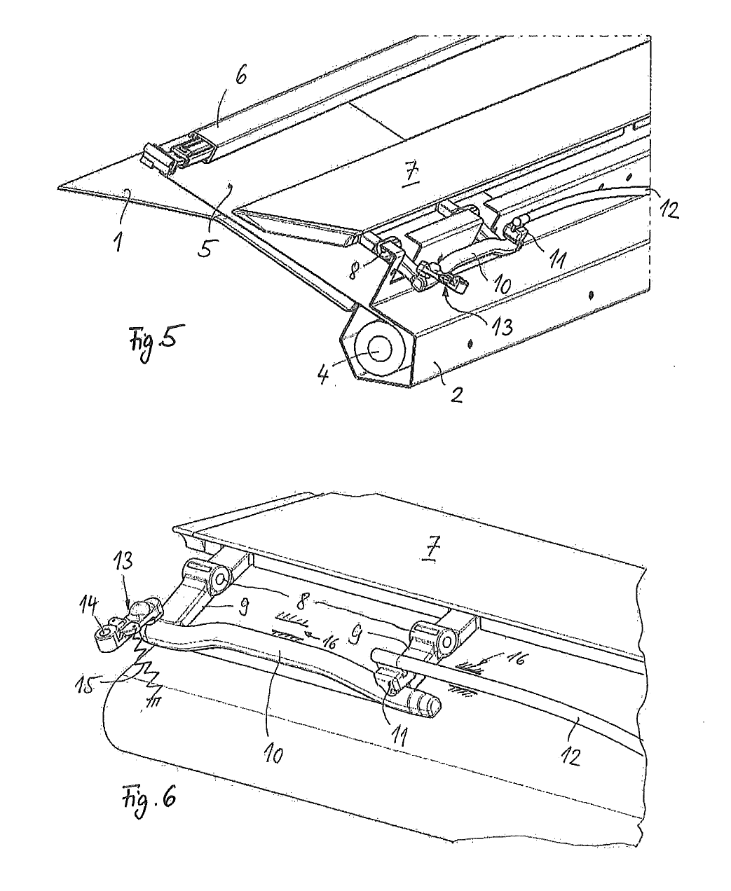

FIG. 5 shows, in an enlarged perspective illustration, the shading device according to FIGS. 1 to 4 in a functional position according to FIG. 4, and

FIG. 6 shows a detail of the shading device according to FIG. 5 in a further perspective and enlarged illustration.

A shading device according to FIGS. 1 to 6 is positioned in the region of a rear parcel shelf 1 below a rear window of a passenger vehicle. The shading device has a flexible sheet-like structure 5 which is held on a winding shaft so as to be able to be wound up and unwound. The winding shaft 4 is mounted rotatably in a receiving space in the form of a cassette housing 2. A winding spring preferably acts on the winding shaft 4 in the winding-up direction. The cassette housing 2 is open via a passage slot and an opening 3 toward a vehicle interior of the passenger vehicle. The opening 3 is closable by a closing part in the form of a flap 7 which is mounted pivotably about a pivot axis 8 extending in the transverse direction of the vehicle. The pivot axis 8 runs parallel above an axis of rotation of the winding shaft 4. A front end region in the pull-out direction of the flexible sheet-like structure 5 is provided with a dimensionally stable pull-out profile 6. The pull-out profile 6 can be transferred by a drive system 12, M into a protective position of the sheet-like structure 5 shading the rear window, and into an inoperative position of the sheet-like structure 5 and of the pull-out profile 6 retracted into the opening 3 below the closing part 7. The drive system has two pull-push strands in the form of flexible threaded shafts which are also referred to as flexible shafts 12. A profile of a flexible shaft 12 is shown schematically with reference to FIG. 2. The flexible shaft 12 which is shown acts on the pull-out profile on an end side of the pull-out profile 6 which is at the rear relative to the plane of the drawing. The two flexible shafts 12 are guided in a linearly movable manner on opposite sides of the rear window in guide rails (not illustrated) in which the end sides of the pull-out profile 6 are also displaceably guided.

The closing part 7 is held permanently in its closed position according to FIG. 1 by a spring device (not illustrated) for as long as no other and oppositely acting forces or torques act on the closed part 7.

According to the invention, the closing part 7 is inevitably transferred into two different opening positions when the pull-out profile 6 is extended upward out of the inoperative position according to FIG. 1 or is moved back again out of an extended functional position in the direction of the inoperative position. For this purpose, the closing part 7 is assigned a control mechanism which is described in more detail below. The closing part 7 is mounted pivotably in the region of the pivot axis 8 by a hinge arrangement on the vehicle side. In the region of the hinge arrangement, a lever arm 9, which is formed by two lever arm portions which are spaced apart parallel to each other, extends from the hinge arrangement in an opposed direction to the closing part 7 and accordingly away from the pivot axis 8. Free end regions of the lever arm portions 9 are connected to each other via a cross member which is configured as a control link 10. The control link 10 is formed by a longitudinally extending profile element which has a double curvature, as a result of which a central slot portion and two outer slot portions arise over the length of the profile portion, said slot portions merging into each other in a flush and aligned manner via curved portions (FIG. 6). The control link 10 extends substantially parallel to the pivot axis 8. A rectilinear control guide 16, which is merely indicated schematically in FIG. 6, extends above the control link 10. The control guide is configured as a guide channel arranged fixed to the vehicle or as a guide groove arranged fixed to the vehicle for the flexible shaft 12. The control guide 16 extends parallel to the pivot axis 8.

An end region of the flexible shaft 12 opposite the pull-out profile 6 is provided with a control cam 11 which projects downward out of the control guide 16, which is configured to be correspondingly open, and is displaceable longitudinally in the control guide 16 together with the flexible shaft 12. The control cam 11 interacts with the control contour of the control link 10. Since the flexible shaft 12 is guided rectilinearly via the rectilinear control guide 16, which runs parallel to the pivot axis 8, the control cam 11 is also guided in a correspondingly rectilinear manner. Since the central link portion of the control link 10 is positioned closer to the control guide 16 than the two opposite outer link portions, the control cam 11, while sliding along the control contour of the control link 10, inevitably pushes the closing part 7 further upward in the central link portion. The control cam 11 has a run-on slope in order to be able to run onto the left end of the control link 10 in FIG. 6 and to be able to push said end downward. In the inoperative position of the pull-out profile 6 according to FIG. 1, the end region of the flexible shaft 12 bearing the control cam 11 is located laterally on the left next to the control link 10 according to the illustrations according to FIGS. 5 and 6. As soon as an electric motor M of the drive system shifts the flexible shafts 12 in the longitudinal direction via the corresponding transmission, the flexible shafts 12 carry along the pull-out profile 6 upward in the direction of the protective position. The flexible shaft 12 according to FIGS. 5 and 6 inevitably moves from the left to the right, as a result of which the control cam 11 comes to bear on the left outer link portion of the control link 10 and transfers the closing part 7 into a first opening position. As the flexible shaft 12 moves further to the right, the control cam 11 inevitably comes to bear on the central link portion via the curved portion, as a result of which the closing part 7 is shifted into its second opening position according to FIG. 3. The length and arrangement of the link portions of the control link 10 are coordinated with the shifting path of the pull-out profile 6 in such a manner that the closing part 7 is located in said second opening position when the pull-out profile 6 emerges through into the vehicle interior under the closing part 7. The control cam 11 subsequently comes to bear on the outer link portion on the right in FIG. 6, as a result of which the spring device inevitably returns the closing part 7 again into the first opening position which lies closer to the rear parcel shelf 1 than the second opening position according to FIG. 3.

During a further extension movement of the pull-out profile 6, the control cam 11 leaves the control link 10.

In order to avoid that, after the control cam 11 is removed from the control link 10, the closing part 7 is pivoted back into the complete closed position according to FIG. 1 by the spring device, the control link 10 is assigned a supporting stop 13 which is configured as a rotary lever which is mounted on a vehicle-fixed functional part so as to be rotatable about an axis of rotation 14. The rotary lever 13 is permanently acted upon with torque in a rotational direction to the right (with respect to the illustrations in FIGS. 5 and 6) by means of a spring unit 15. The supporting stop 13 lies in the movement path of the control cam 11 and the flexible shaft 12. As long as the control cam 11 and the flexible shaft 12 are located in the inoperative position, the control cam 11 presses the supporting stop 13 to the left into an inoperative position in which it is disengaged from the control link 10. If the control cam 11 is shifted to the right in the control guide 16 together with the flexible shaft 12, the spring unit 15 inevitably also rotates the supporting stop 13 to the right until the supporting stop 13 is located above the outer link portion of the control link 10. If the control cam 11 is then removed upward from the control link 10 by shifting of the flexible shaft 12 together with the pull-out profile 6, the spring device (not illustrated) inevitably pulls the closing part 7 again in the direction of its closed position. The left outer link portion of the control link 10 comes to bear from below against the supporting stop 13, as a result of which the closing part 7 is held in an opening position according to FIG. 4. Said opening position is configured in such a manner that the closing part 7 remains at a distance from the sheet-like structure 5 while the latter is pulled out upward in the direction of the protective position. As illustrated schematically with reference to FIG. 2, the flexible shaft 12 is curved and deflected from the parallel orientation next to the sheet-like structure 5 to the transverse orientation in the region of the control guide 16. Since, however, the flexible shaft 12 has corresponding elastic flexibility, such a deflection and curvature are possible without damage or excessive loading of the flexible shaft 12. As long as the pull-out profile 6 remains in the pulled-out protective position of the sheet-like structure 5, the supporting stop 13 supports the closing part 7 in the opening position according to FIG. 4. If the pull-out profile 6 and the sheet-like structure 5 are returned again in the direction of the inoperative position according to FIG. 1, the flexible shaft 12 is also returned again in a corresponding manner. The control cam 11 inevitably comes again to bear against the right outer link portion of the control link 10 shortly before the region in which the closing part 7 is located in the movement path of the pull-out profile 6, and correspondingly moves in the opposite direction along the control link 10, as a result of which the closing part 7 is pivoted upward again according to FIG. 3 and the pull-out profile 6 can move into the opening 3 without contact. As soon as the control cam 11 has reached the supporting stop 13, the control cam 11 pushes the supporting stop 13 again to the left counter to the spring force of the spring unit 15. If the control cam 11 has moved to the left beyond the left link portion of the control link 10, the control link 10 is completely released by the control cam 11, and therefore the closing part 7 is pivoted again into the closed position according to FIG. 1 by means of the spring device.

1. A shading device for a window of a motor vehicle, with a flexible sheet-like structure which is held on a winding shaft so as to be able to be wound up and unwound between a wound-up inoperative position and a stretched protective position, which winding shaft is mounted rotatably in a vehicle-mounted receiving space which is closable by a closing part which is mounted pivotably between a closed position and at least one opening position, wherein the sheet-like structure is provided at its front end region in the unwinding direction with a dimensionally stable pull-out profile which is shiftable parallel along the window by means of a drive system, wherein the closing part is forcibly controlled by means of a control mechanism between at least two different opening positions, of which a first opening position opens up an opening permitting passage of the pull-out profile, and a second opening position opens up a reduced opening which is selected to be of a size sufficient in order to permit the flexible sheet-like structure to pass through without contact.

2. The shading device as claimed in claim 1, wherein the control mechanism is assigned to a lever arm of the closing part.

3. The shading device as claimed in claim 2, wherein the control mechanism has a control link arranged in the region of the lever arm and a control cam which is movable along the control link, wherein the control link has various link track portions which define the two opening positions of the closing part.

4. The shading device as claimed in claim 3, wherein the control link is arranged on the lever arm.

5. The shading device as claimed in claim 1, the control link is arranged on a guide track for the control cam.

6. The shading device as claimed in claim 1, wherein the drive system has two bendable, longitudinally extending pull-push strands which are operatively connected at an end region to the pull-out profile for parallel shifting, wherein at least one pull-push strand is guided by its opposite end region in a control guide in the region of the lever arm.

7. The shading device as claimed in claim 6, wherein the end region of the pull-push strand is provided with the control cam.

8. The shading device as claimed in claim 1, wherein the control guide has the link track portions of the control link.

9. The shading device as claimed in claim 1, wherein a supporting stop which can be activated and deactivated by the end region of the pull-push strand is provided, said supporting stop holding the closing part in one of the two opening positions.
